(19) United States
(12) Patent Application Publication
(10) Pub. No.: US 2026/0109417 A1
(43) Pub. Date: Apr. 23, 2026

(54) WEAR MEMBER AND TRACK LINK FOR TRACK LINK ASSEMBLY

(71) Applicant: Caterpillar Inc., Peoria, IL (US)

(72) Inventors: Samprati V. SHAH, Peoria, IL (US); Matthew W. TRONE, Metamora, IL (US); William BAAR, Peoria, IL (US)

(73) Assignee: Caterpillar Inc., Peoria, IL (US)

(21) Appl. No.: 18/919,571

(22) Filed: Oct. 18, 2024

(51) Int. Cl. B62D 55/205

(52) U.S. Cl. CPC B62D 55/205

(57) ABSTRACT

A wear member for a track link of a track link assembly may include a plurality of surfaces, including an upper surface and an opposite planar lower surface. The device may also include a front portion and a back portion, as well as a plurality of dowels extending from the lower surface, including at least one dowel provided on one of the front portion and at least one dowel provided on the back portion of the wear member.

### TECHNICAL FIELD

The present disclosure relates generally to a track link assembly, and, more particularly, to a wear member and a track link for a track link assembly.

### BACKGROUND

Track assemblies of track type machines, such as dozers, excavators, and skid-steer loaders, include a loop of link assemblies that support a loop of track shoes as the loop rotates around a sprocket and an idler assembly. In an offset link arrangement, each track link assembly includes a pair of track links mounted to a bushing, at a front end, and a pin, at a back end. Each track link assembly is pivotably connected to adjacent link assemblies, in the loop, using bushings and pins. Track shoes are attached to each link assembly using bolts and nuts. Typically, track links are forged into relatively complex three-dimensional shapes, or they are formed by multiple pieces that are welded together. In either case, manufacturing track links can be costly due to the complexity of the final product, and the time and material required to form the final product. Further, the wear life of a track link differs from that of other components, specifically, the bushing, which results in users having to service machines more frequently to replace different components with different wear lives.

U.S. Patent No. 3,947,074 describes a track link assembly, with rail segments and track shoes that are secured to the track links with shoulder bolts, and pins and bushings connecting adjacent pairs of track links. Removal of the shoulder bolts permits interchanging (or reversing) of the rail segments and track shoes and reattachment thereof. The rail segments must be reversible, though reversing of rail segments requires disassembly of bolt and nut attachments, and reassembly thereof. The track link assemblies of the ‘074 patent also do not address problems associated with the need to frequently service such machines to replace different components, i.e., the bushings and the rail segments.

The wear member and track link assembly of the present disclosure may solve one or more of the problems set forth above and/or other problems in the art. The scope of the current disclosure, however, is defined by the attached claims, and not by the ability to solve any specific problem.

### SUMMARY

In one aspect of the present disclosure, a wear member for a track link may include a plurality of surfaces, including an upper surface and an opposite planar lower surface; a front portion; a back portion; and a plurality of dowels extending from the lower surface, including at least one dowel provided on one of the front portion and at least one dowel provided on the back portion of the wear member.

In another aspect of the present disclosure, a wear member for a track link may include a plurality of surfaces, including an upper surface and a planar lower surface; a front portion; a back portion; and a plurality of dowels extending from the lower surface, the plurality of dowels being provided offset from each other relative to a central longitudinal axis of the wear member.

In still another aspect of the present disclosure, a wear member and track link assembly may include a track link having a plurality of surfaces, including an upper surface having a plurality of pin holes, and the track link further having a front portion and a back portion, with at least one pin hole being provided in the front portion and at least one pin hole being provided in the back portion of the track link. The wear member and track link assembly may also include a wear member having: a plurality of surfaces, including an upper surface and a planar lower surface; a front portion; a back portion; and a plurality of dowels extending from the lower surface, each of the plurality of dowels being provided in one of the front portion and the back portion of the wear member, wherein the plurality of dowels of the wear member are configured for placement within the plurality of pin holes of the track link, with an interference fit between the plurality of dowels and the plurality of pins connecting the wear member and the track link.

### BRIEF DESCRIPTION OF THE DRAWINGS

FIG. 1 shows a side view of a dozer, as an example of a track type machine, having track link assemblies, each including a wear member and a track link, in accordance with the present disclosure.

FIG. 2 shows an exploded isometric view of a wear member and a track link, in accordance with the present disclosure.

FIG. 3 shows a side exploded side view of the wear member and the track link, shown in FIG. 2, in accordance with the present disclosure.

FIG. 4 shows an exploded detail view of a portion of the wear member and a portion of the track link, shown in FIG. 2 and FIG. 3, in accordance with the present disclosure.

FIG. 5 shows a view of lower surface of the wear member, shown in FIG. 2, FIG. 3, and FIG. 4, in accordance with the present disclosure.

FIG. 6 shows an exploded isometric view of a wear member and a track link, in accordance with the present disclosure.

FIG. 7 shows a view of lower surface of the wear member, shown in FIG. 6.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

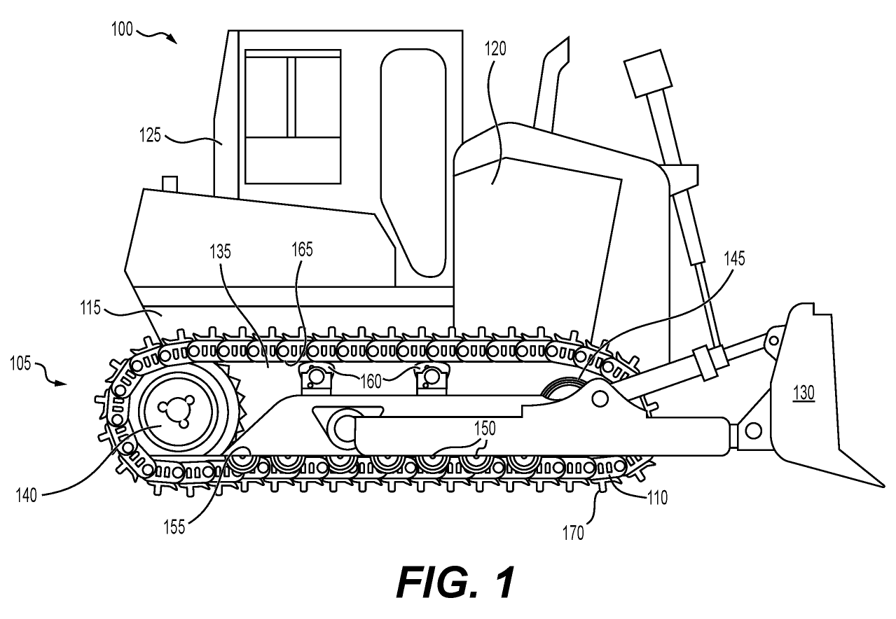

FIG. 1 shows a side view of a track type machine 100 having a track assembly 105 including a plurality of track link assemblies 110, in accordance with the present disclosure. The machine 100 also includes a machine frame 115 supporting an engine 120, an operator station 125, and a work tool or implement 130. The machine 100 also includes a track support frame 135, provided as part of the undercarriage of the machine frame 115. The track support frame 135 supports the track assembly 105, the work tool 130, a sprocket 140, and an idler assembly 145, including idlers and rollers (not shown). The track assembly 105 includes lower track support assemblies 150, provided on a lower surface 155 of the track support frame 135, and upper track support assemblies 160, provided on an upper surface 165 of the track support frame 135. The plurality of track link assemblies 110 are arranged in a loop extending around the lower track support assemblies 150 and the upper track support assemblies 160. The track assembly 105 further includes track shoes 170, connected to the track link assemblies 110. During operation, the engine 120 may generate a power output directed through the sprocket 140, which transmits a force to move the track link assemblies 110 and the track shoes 170, some of which are engaged with a ground material, to propel the machine 100 forwards or backwards.

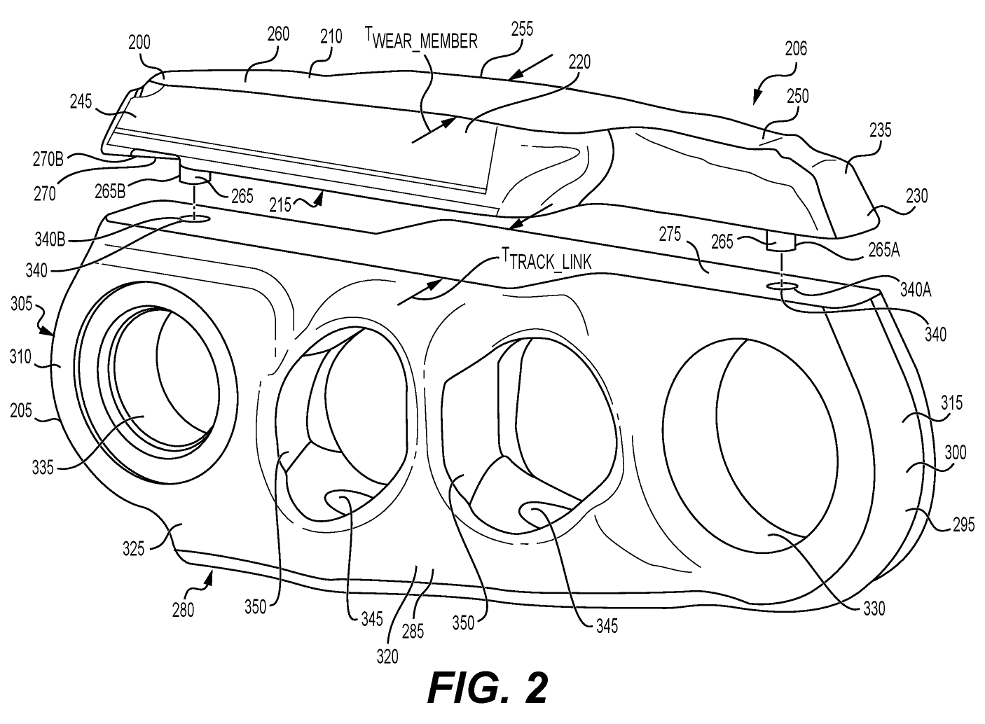

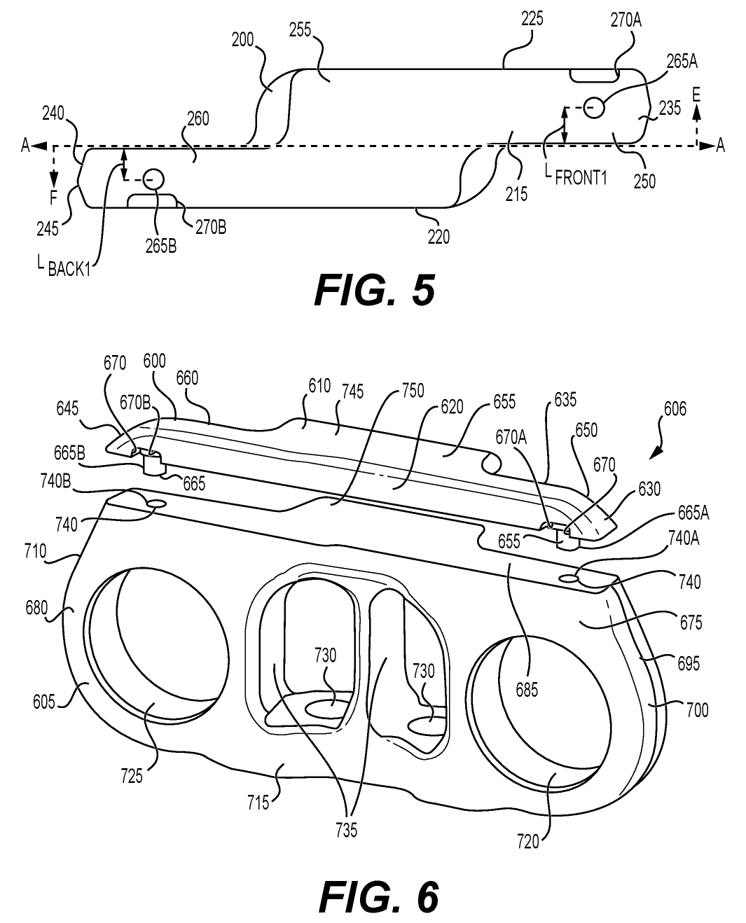

FIG. 2 shows an exploded isometric view of a wear member 200 and a track link 205 of a wear member and track link assembly 206, in accordance with the present disclosure. In particular, FIG. 2 shows the wear member 200, having a plurality of surfaces, including an upper surface 210, a lower surface 215 (also shown in FIG. 5) that is opposite to the upper surface 210, an inner surface 220, an outer surface 225 (shown in FIG. 5) that is opposite to the inner surface 220, a front surface 230 at a front end 235 of the wear member 200, and a back surface 240 (shown in FIG. 5) that is opposite to the front surface 230 and that is located at a back end 245 of the wear member 200. The wear member 200 may be defined by a front portion 250, a central portion 255, and a back portion 260. The front portion 250 may overlap, or be aligned, with a front portion 315 of the track link 205, described below, the front portion 315 being the portion which includes a bushing bore 330. The back portion 250 may overlap, or be aligned, with a back portion 325 of the track link 205, described below, the back portion 325 being the portion which includes a pin bore 335. The central portion 255 may overlap, or be aligned with, a central portion 320 of the track link 205, described below, the central portion 320 being the portion which includes bolt holes 345 and windows 350 of the track link 205. The front portion 315 and the back portion 250 may be delineated from the central portion 255 by a vertical axis extending along a side of each window 350, the side being closest to the front end 235 and the back end 245, respectively.

The upper surface 210 may be free from protrusions or indentations. The upper surface 210 may be planar, or it may be slightly curved or arced along its length, in an upward direction (relative to the direction shown in FIG. 2). The upper surface 210 may be configured for abutment with an idler and a track roller of an idler assembly 145, and may also be referred to as a rail side of the wear member and track link assembly 206. The lower surface 215 has a plurality of protrusions, or dowels 265 extending therefrom. In some embodiments, the lower surface 215 may also include one or more recesses 270, discussed in more detail below, and apart from the dowels 265 and the recesses 270, the lower surface 215 may otherwise be free from indentations and any other protrusions. The wear member 200 may only include dowels on one or both of the front portion 250 and the back portion 260, and may have no dowels on the central portion 255. The lower surface 215 may be planar, apart from the dowels 265 and recesses 270. The lower surface 215 may be congruent with the upper surface 275 of the track link 205, and may be configured for abutment and engagement with an upper surface 275 of the track link 205, as discussed in more detail below.

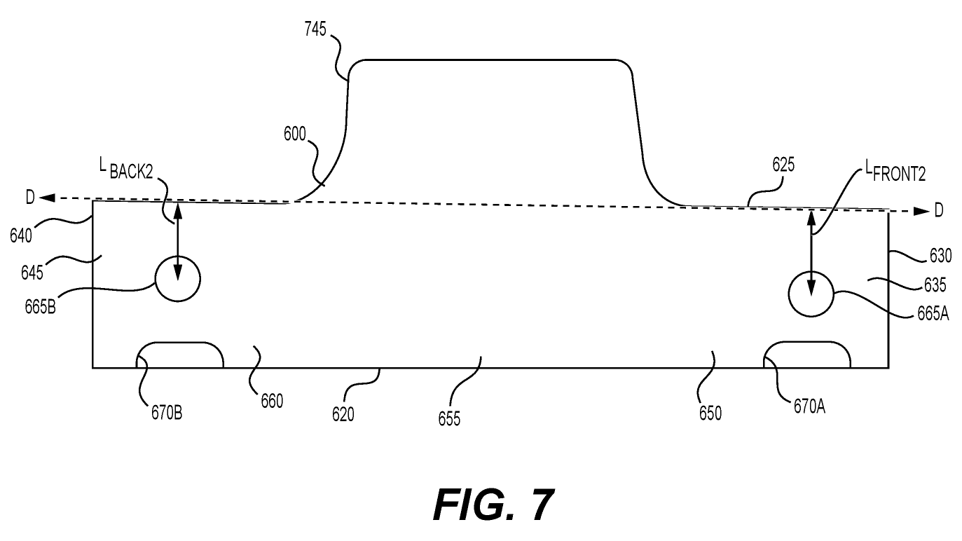

In one embodiment the plurality of dowels 265 may, for example, include two dowels 265, namely, a front dowel 265A, in the front portion 250 of the wear member 200, and a back dowel 265B, in the back portion 260 of the wear member 200. The two dowels 265A and 265B may be offset from each other relative to a central longitudinal axis A-A of the wear member 200 (also shown in FIG. 5), with the front dowel 265A being provided on one side E of the central longitudinal axis A-A, and the back dowel 265B being provided on another side F of the central longitudinal axis A-A. The front dowel 265A may be offset by a length L_{FRONT1}, and the back dowel 265B may be offset by a length L_{BACK1}, as shown in FIG. 7 and discussed in more detail below. According to this embodiment, the offset arrangement of the dowels 265A and 265B corresponds to the arrangement of pin holes 340 provided in the upper surface 275 of the track link 205, discussed in more detail below.

As noted above, one or more recesses 270 or notches may be provided on the lower surface 215, as shown in FIG. 5. In the embodiment in which the wear member 200 has a front dowel 265A and a back dowel 265B, the recesses 270 may include a front recess 270A extending from the inner surface 220 of the wear member 200 toward the front dowel 265A, and a back recess 270B extending from the outer surface 225 of the wear member 200 toward the back dowel 265B. In one embodiment, a single recess 270 may be provided, such as only the front recess 270A or only the back recess 270B. In other embodiments, two or more recesses 270 may be provided. The recesses 270 may be referred to as “chiseled recesses,” in that a chisel or similar type of tool may be inserted into the recesses 270 to remove the wear member 200 from the track link 205, as discussed in more detail below. The inner surface 220, the outer surface 225, the front surface 230, and the back surface 240 may include contours matching those of corresponding surfaces of the track link 205.

The surfaces of the track link 205 include an upper surface 275, a lower surface 280 that is opposite to the upper surface 275, an inner surface 285, an outer surface (not shown) that is opposite to the inner surface 285, a front surface 295 at a front end 300 of the track link 205, and a back surface 305 at a back end 310 of the track link 205. The track link 205 also has a front portion 315, a central portion 320, and a back portion 325. In the embodiment shown in FIG. 2, the track link 205 is an offset track link, meaning the front portion 315 and the back portion 325 are offset from each other relative to a central longitudinal axis of the track link 205. The track link 205 also has a bushing bore 330, as an opening extending from the inner surface 285 to the outer surface 290, in the front portion 315 of the track link 205, and a pin bore 335, as another opening extending from the inner surface 285 to the outer surface 290, in the back portion 325 of the track link 205. The upper surface 275 has a plurality of pin holes 340, or openings, extending into the track link 205, and may otherwise be free from any other openings, indentations, or protrusions. The plurality of pin holes 340 may be provided in one or both of the front portion 315 and the back portion 325 of the track link 205, while the central portion 320 of the track link 205 may have no pin holes. In one embodiment, the track link 205 may include a front pin hole 340A within the front portion 315, and a back pin hole 340B within the back portion 325. The upper surface 275 may be planar, apart from the pin holes 340. The upper surface 275 may be congruent with the lower surface 215 of the wear member 200, and may be configured for abutment and engagement with the lower surface 215 of the wear member 200, and the dowels 265 are configured for placement within or mating with the pin holes 340. That is, when the wear member 200 is mounted to the track link 205, the dowels 265 on the lower surface 215 of the wear member 200 are placed within or received within the pin holes 340 on the upper surface 275 of the track link 205, and the lower surface 215 of the wear member 200 abuts the upper surface 275 of the track link 205.

Further, the track link 205 includes at least one bolt hole 345, extending through the central portion 320 from the lower surface 280 of the track link 205 toward the upper surface 275 of the track link 205, and in a direction that is perpendicular to that of the pin bore 335 in the front portion 315 and the bushing bore 330 in the back portion 325. That is, the bolt hole 345 extends into the lower surface 280 of the track link 205, the lower surface 280 being a surface that supports a track shoe 170. In the embodiment shown in FIG. 2, for example, the track link 205 includes two bolt holes 345. The bolt holes 345 are configured to receive bolts and nuts (not shown) for connecting or attaching a track shoe 170 to the track link 205. The track link 205 may also include one or more windows 350, each window 350 intersecting a bolt hole 345. The window 350 is an opening extending through the central portion 320, between the inner surface 285 and the outer surface 290 of the track link 205, in a direction that is perpendicular to a longitudinal axis of the bolt holes 345, such that the window 350 intersects the corresponding bolt hole 345.

In one or more embodiments, the dowels 265 on the wear member 200 and the pin holes 340 on the track link 205 may be arranged so that the wear member 200 may only be mounted to the track link 205 in one way (i.e., the wear member 200 could not be mounted in a way such that the front end 235 is mounted to the back end 310 of the track link 205, and the back end 245 is mounted to the front end 300 of the track link 205). This arrangement may include, for example, providing dowels 265 at varying lengths from the central longitudinal axis A-A of the wear member 200, and providing pin holes 340 at corresponding lengths as the dowels 265, within the upper surface 275 of the track link 205. In other embodiments, the dowels 265 and the pin holes 340 may be arranged so that the wear member 200 may be mounted to the track link 205 in two ways (i.e., the wear member 200 may be turned, so that the front end 235 is mounted to the back end 310 of the track link 205 and the back end 245 is mounted to the front end 300 of the track link 205).

In one or more embodiments, the wear member 200 may be formed of a different material than the track link 205. For example, the wear member 200 may be formed of composite materials, alternative wrought steel materials, or various heat-treat steel materials, and the track link 205 may be formed of alternative wrought steel materials or various heat-treated steel materials. In other embodiments, the wear member 200 may be formed of the same material as the track link 205.

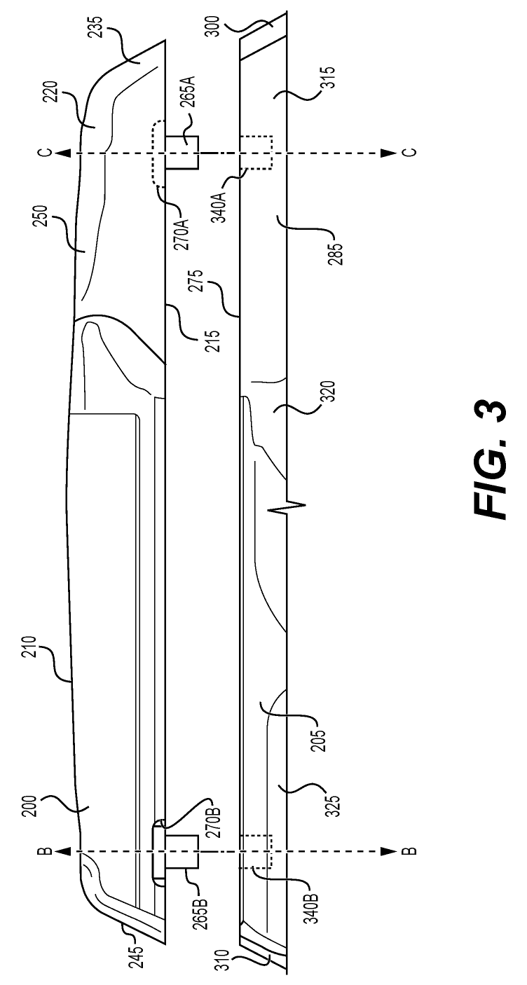

FIG. 3 shows a side exploded side view of the wear member 200 and the track link 205, shown in FIG. 2, in accordance with the present disclosure. In particular, FIG. 3 shows the inner surface 220 of the wear member 200, as well as the dowels 265 extending from the lower surface 215 of the wear member 200. The front end 235 and the back end 245 of the wear member 200 are also shown, with the dowels 265 being located on the front portion 250 and the back portion 260 of the wear member 200, and no dowels being provided on the central portion 255 thereof. FIG. 3 also shows the recesses 270, including the front recess 270A, shown in dashed lines, and provided in the front portion 250 of the wear member 200, extending from the outer surface 225 toward the front dowel 265A, and the back recess 270B, provided in the back portion 260 of the wear member 200, and extending from the inner surface 220 toward the back dowel 265B. FIG. 3 also shows the inner surface 285 of the track link 205, and, in dashed lines, shows the pin holes 340 extending into the track link 205 from the upper surface 275 thereof. One of the pin holes 340 is provided in the front portion 315 of the track link 205, and the other one of the pin holes 340 is provided in the back portion 325 of the track link 205, with no pin holes being located in a central portion 320 of the track link 205. FIG. 3 also shows the alignment between the dowels 265 of the wear member 200 and the pin holes 340 of the track link 205, along axes B-B and C-C.

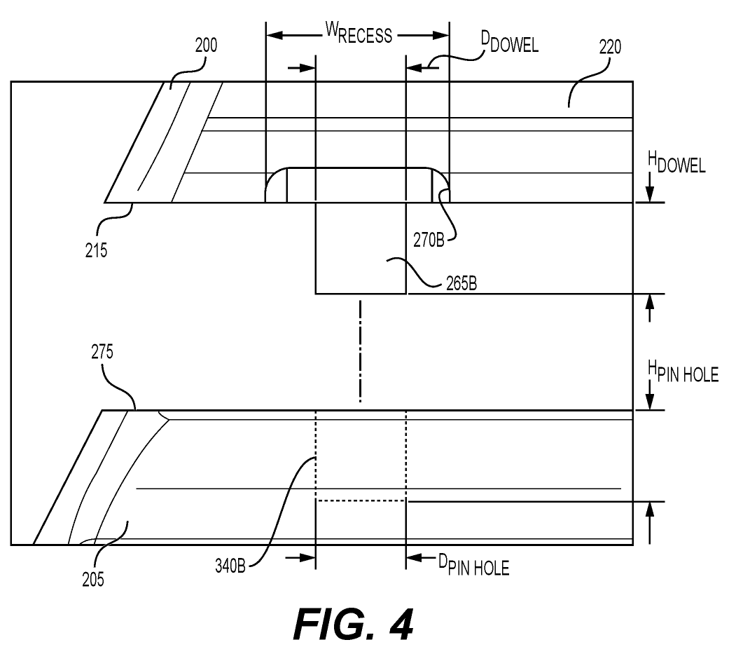

FIG. 4 shows an exploded detail view of a portion of the wear member 200 and a portion of the track link 205, shown in FIG. 2 and FIG. 3, in accordance with the present disclosure. In particular, FIG. 4 shows the back dowel 265B, as an example of a dowel 265 provided on the lower surface 215 of the wear member 200, and the back pin hole 340B, as an example of a pin hole 340 provided on the upper surface 275 of the track link 205. FIG. 4 also shows the back recess 270B provided on the wear member 200, and extending from the inner surface 220 of the wear member 200, toward the dowel 265B. FIG. 4 also shows the alignment between the dowel 265B and the pin hole 340B. FIG. 4 also shows the relative dimensions of the back dowel 265B, the back pin hole 340B, and the back recess 270B. In particular, FIG. 4 shows a diameter D_{DOWEL} and a height H_{DOWEL} of the back dowel 265B, a diameter D_{PIN HOLE} and a height H_{PIN HOLE} of the back pin hole 340B, and a width W_{RECESS} of the back recess 270B.

The diameter D_{DOWEL} may be in a range of about 9 mm to about 20 mm. In some embodiments, the diameter D_{DOWEL} and the height H_{DOWEL} may be based on, for example, the number of dowels 265 provided on the wear member 200 and/or a thickness T_{WEAR_MEMBER} of the wear member 200. In one embodiment, the diameter D_{DOWEL} may be about 40% of the thickness T_{WEAR_MEMBER} of the wear member 200, or less. The thickness T_{WEAR_MEMBER} is measured between the inner surface 220 and the outer surface 225 of the wear member 200, and as the thickness may vary, for purposes of determining the diameter D_{DOWEL}, the thickness T_{WEAR_MEMBER} may be a maximum thickness of the wear member 200. The thickness T_{WEAR_MEMBER} may also be the same as a thickness T_{TRACK_LINK} of the track link 205. Thus, the size (e.g., diameter, height) of the dowel 265 may be determined based on the size (e.g., thickness) of the wear member 200 and, in turn, the size (e.g., thickness) of the track link 205 to which the wear member 200 is to be attached. The dowels 265 may have a cylindrical shape providing a circular cross section (shown in FIG. 5). The dowels 265 may, however, have other shapes and cross sections.

The diameter D_{PIN HOLE} may be slightly greater than the diameter D_{DOWEL}, and may be configured for an interference fit between the dowel 265 and the pin hole 340. The height H_{PIN HOLE} may also be slightly greater than the height H_{DOWEL}. As noted above, the size (diameter, height) of the dowels 265 may be determined based on the size (e.g., the thickness) of the track link 205 to which the wear member 200 is to be attached, and the size (diameter, depth) of the pin holes 340 may similarly be determined based on the size (e.g., thickness) of the track link 205. The pin holes 340, like the dowels 265, may have a cylindrical shape, or they may have other shapes. The dowels 265 and the pin holes 340 may mate and, once mated, form an interference fit, when the dowels 265 are received and positioned within the pin holes 340. Other types of joining or engineering fits between the wear member 200 and the track link 205 may be used.

The recess 270B may be generally trapezoidal in shape, with curved or rounded corners, as shown in FIG. 5. The recess may, however, have other shapes, such as generally rectangular. The width W_{RECESS} may be at least about 20 mm. The width W_{RECESS} may be greater than 20 mm, and in some embodiments, the width W_{RECESS} may be based on the thickness T_{WEAR_MEMBER}, which may, in turn, be based on the thickness T_{TRACK_LINK}.

FIG. 5 shows a view of the lower surface 215 of the wear member 200, shown in FIG. 2, FIG. 3, and FIG. 4, in accordance with the present disclosure. In particular, FIG. 5 shows the lower surface 215 of the wear member 200, including dowels 265 and recesses 270, including the front dowel 265A on the front portion 250 of the wear member 200, the back dowel 265B on the back portion 260 of the wear member 200, the front recess 270A, on the front portion 250 of the wear member 200, extending from the outer surface 225 toward the front dowel 265A, and the back recess 270B, on the back portion 260 of the wear member 200, extending from the inner surface 220 toward the back dowel 265B.

FIG. 5 also shows the offset arrangement of the front dowel 265A and the back dowel 265B, relative to the central longitudinal axis A-A of the wear member 200. In particular, the length L_{FRONT1} between a center of the front dowel 265A and the central longitudinal axis A-A and the length L_{BACK1} between a center of the back dowel 265B and the central longitudinal axis A-A are shown. In some embodiments, the lengths L_{FRONT1} and L_{BACK1} may be equal to each other. In other embodiments, the lengths L_{FRONT1} and L_{BACK1} may be different from each other. Similarly, in embodiments with more than two dowels 265, the lengths between centers of the dowels 265 to the central longitudinal axis A-A may be equal as to all dowels 265, or may vary among the dowels 265.

FIG. 6 shows an exploded isometric view of a wear member 600 and a track link 605, of a wear member and track link assembly 606, in accordance with another embodiment of the present disclosure. In particular, FIG. 6 shows the wear member 600 having a plurality of surfaces, including an upper surface 610, a lower surface 615 (shown in FIG. 7) that is opposite to the upper surface 610, an inner surface 620, an outer surface 625 (shown in FIG. 7) that is opposite to the inner surface 620, a front surface 630 at a front end 635 of the wear member 600, and a back surface 640 (not shown) that is opposite to the front surface 630 and that is located at a back end 645 of the wear member 600. The wear member 600 may have a front portion 650, a central portion 655, and a back portion 660. The upper surface 610 may be free from protrusions or indentations. The upper surface 610 may be planar, or it may be slightly curved or arced along its length, in an upward direction. The upper surface 610 may be configured for abutment with an idler and a track roller of an idler assembly 145. The lower surface 615 has a plurality of dowels 665, or protrusions, extending therefrom. In some embodiments, the lower surface 615 may also include one or more recesses 670, discussed below, and may otherwise be free from indentations and any other protrusions. The wear member 600 may only include dowels 665 on one or both of the front portion 650 and the back portion 660, and may have no dowels on the central portion 655. The lower surface 615 may be planar, apart from the dowels 665 and the one or more recesses 670. The lower surface 615 may be congruent with the upper surface 685 of the track link 605 and may be configured for abutment and engagement with an upper surface 685 of the track link 605, as discussed in more detail below.

In one embodiment the plurality of dowels 665 may, for example, include two dowels, namely, a front dowel 665A, on the front portion 650 of the wear member 600, and a back dowel 665B, on the back portion 660 of the wear member 600. The two dowels 665A and 665B may be aligned with each other and offset by a distance, e.g., lengths L_{FRONT2} and L_{BACK2}, respectively, shown in FIG. 7, relative to a central longitudinal axis D-D (also shown in FIG. 7) of the wear member 600, with the front dowel 665A being provided on one side (here, a side toward the inner surface 620) of the central longitudinal axis D-D, and the back dowel 665B being provided on the same side of the central longitudinal axis D-D. The aligned arrangement of the dowels 665 corresponds to the arrangement of pin holes 740 provided in the upper surface 685 of the track link 605, discussed in more detail below.

As noted above, one or more recesses 670 or notches may be provided. In the embodiment shown in FIG. 6, the recesses 670 include a front recess 670A extending from the inner surface 620 toward the front dowel 665A, and a back recess 670B extending from the inner surface 620 toward the back dowel 665B. In some embodiments, the recesses 670 may extend from the outer surface 625 toward the dowels 665. In one embodiment, a single recess 670 may be provided. In other embodiments, two or more recesses 670 may be provided. The recesses 670 may be referred to as “chiseled recesses,” in that a chisel or similar type of tool may be inserted into the recesses 670 to remove the wear member 600 from the track link 605, as discussed in more detail below. The inner surface 620, the outer surface 625, the front surface 630, and the back surface 640 may include contours matching those respective surfaces of the track link 605.

The track link 605 of this embodiment differs from that of the embodiment shown in FIGS. 2 to 5, in that it includes a front portion 675 and a back portion 680 that are aligned with each other, rather than being offset from each other. The track link 605 shown in FIG. 6 otherwise has the same features as the track link 205 shown in FIG. 2, namely, the plurality of surfaces, including an upper surface 685, a lower surface (not shown) that is opposite to the upper surface 685, an inner surface 690, an outer surface (not shown) that is opposite to the inner surface 690, a front surface 695 at a front end 700, and a back surface 705 at a back end 710, the front portion 675, a central portion 715, and the back portion 680, as well as a bushing bore 720, a pin bore 725, at least one bolt hole 730, and one or more windows 735.

The upper surface 685 of the track link 605 of this embodiment also has a plurality of pin holes 740, extending into the track link 605, and may otherwise be free from any other openings, indentations, or protrusions. The plurality of pin holes 740 may be provided in one or both of the front portion 675 and the back portion 680 of the track link 605, while the central portion 715 of the track link 605 may have no pin holes. The upper surface 685 may be planar, apart from the pin holes 740. The upper surface 685 may be congruent with the lower surface 615 of the wear member 600 and may be configured for abutment and engagement with the lower surface 615 of the wear member 600, and the dowels 665 are configured for placement within or mating with the pin holes 740. That is, when the wear member 600 is mounted to the track link 605, the dowels 665 on the lower surface 615 of the wear member 600 are placed within or received within the pin holes 740 on the upper surface 685 of the track link 605, and the lower surface 615 of the wear member 600 abuts the upper surface 685 of the track link 605.

In one or more embodiments, the dowels 665 on the wear member 600 and the pin holes 740 on the track link 605 may be arranged so that the wear member 600 may only be mounted to the track link 605 in one way (i.e., the wear member 600 could not be mounted to the track link 605 such that the front end 635 of the wear member 600 is mounted to the back end 710 of the track link 605, and the back end 645 of the track link 605 is mounted to the front end 700 of the track link 605).

The central portion 655 of the wear member 600 may include a protruded portion 745, and the central portion 715 of the track link 605 may include a protruded portion 750. The shapes of the protruded portion 745 of the wear member 600 and the protruded portion 750 of the track link 605 may have the same shape or outer contour, as shown in FIG. 6. The protruded portion 745 of the wear member 600 may be on an outer side (i.e., a side toward the outer surface 625) of the central longitudinal axis D-D of the wear member 600, that is, on a side opposite to the side on which the dowels 665 are provided. Similarly, the protruded portion 750 of the track link 605 may be on an outer side (i.e., a side toward the outer surface) of the track link 605. By virtue of the arrangement of the protruded portions, and there being no protruded portions on the other side of the wear member 600 and the track link 605, the wear member 600 cannot be mounted in a backwards, or wrong, configuration (that is, the wear member 600 cannot be mounted to the track link 605 so that the front end 635 of the wear member 600 is mounted to the back end 710 of the track link 605, and the back end 645 of the wear member 600 is mounted to the track link 605, such that the protruded portion 745 of the wear member 600 overhangs an edge of the track link 605, and thus indicating improper installation of the wear member). That is, the wear member 600 can be mounted to the track link 605 in only one configuration or orientation, with the front end 635 of the wear member 600 mounted to the front end 700 of the track link 605, and the back end 645 of the wear member 600 mounted to the back end 710 of the track link 605.

As with the embodiment shown in FIGS. 2 to 5, the wear member 600 of this embodiment may be formed of a different material than the track link 605. For example, the wear member 600 may be formed of composite materials, alternative wrought steel materials, or various heat-treat steel materials, and the track link 605 may be formed of alternative wrought steel materials or various heat-treated steel materials. In other embodiments, the wear member 600 may be formed of the same material as the track link 605. The dimensional relationships of the dowels 665, pin holes 740, and track link 605 may be the same as described above with respect to FIGS. 2 to 5.

FIG. 7 shows a view of the lower surface 615 of the wear member 600, shown in FIG. 6. In particular, FIG. 7 shows the lower surface 615 of the wear member 600, including dowels 665 and recesses 670. The embodiment of FIG. 7 includes two dowels 665, namely, the front dowel 665A on the front portion 675 of the wear member 600, and the back dowel 665B on the back portion 660 of the wear member 600. Each dowel 665 has a corresponding recess 670, namely, the front recess 670A, on the front portion 675 of the wear member 600, extending from the inner surface 690 toward the front dowel 665A, and the back recess 670B, on the back portion 660 of the wear member 600, extending from the inner surface 620 toward the back dowel 665B.

FIG. 7 also shows the aligned arrangement of the front dowel 665A and the back dowel 665B, relative to the central longitudinal axis D-D of the wear member 600. In particular, the length L_{FRONT2} between a center of the front dowel 665A and the central longitudinal axis D-D and the length L_{BACK2} between a center of the back dowel 665B and the central longitudinal axis D-D are shown, and in this embodiment, both the front dowel 665A and the back dowel 665B are on one side (i.e., toward the inner surface 620) of the central longitudinal axis D-D. In some embodiments, the lengths L_{FRONT2} and L_{BACK2} may be equal to each other. In other embodiments, the lengths L_{FRONT2} and L_{BACK}1 may be different from each other. Similarly, in embodiments with more than two dowels, the lengths between centers of dowels 665 to the central longitudinal axis D-D may be equal as to all dowels, or may vary as to the different dowels 665.

### Industrial Applicability

The wear members 200 and 600, the track links 205 and 605, and the wear member and track link assemblies 206 and 606, in accordance with the present disclosure, can be used in track type machines 100, such as track-type tractors, dozers, excavators, and skid-steer loaders. Specifically, wear member and track link assemblies 206 and 606, in accordance with the present disclosure, can be used to form track link assemblies 110 that support track shoes 170, and, as the track link assemblies 110 rotate, in a loop, around a sprocket 140 and an idler assembly 145, including idlers and rollers (not shown), the track shoes 170 engage with a surface (terrain), to move the track type machine 100 forwards or backwards.

In use, the wear member 200 (or the wear member 600, although only wear member 200 and track link 205 will be referred to below for simplicity) is configured to be mounted to the track link 205, with the plurality of dowels 265 being placed within or received within the plurality of pin holes 340 of the track link 205. The wear member 200 and the track link 205 may be joined together via an interference fit between the dowels 265 and the pin holes 340. The assembly 206, including the wear member 200 and the track link 205 can be used as part of a track link assembly 110. When the wear member 200 reaches the end of its useful life (i.e., the wear member 200 has worn down to a predetermined thickness, measured between the lower surface 215 and the upper surface 210), a tool, such as a chisel, may be inserted into one or more of the recesses 270, and the wear member 200 may be pried off of the track link 205 by applying force to the tool (e.g., a downward or upward force exerted on a handle of the tool may transfer to the end of the tool within the recess 270, and transfer to the wear member 200 or the track link 205 to move away from the other of the wear member 200 or the track link 205). Once the wear member 200 has been pried off of the track link 205, a new wear member 200 may be mounted to the track link 205, with the plurality of dowels 265 of the new wear member 200 being placed within or received within the plurality of pin holes 340 of the track link 205.

The wear member 200, track link 205, and related wear member and track link assembly 206 (or the wear member 600, track link 605, and wear member and track link assembly 606, although only wear member 200, track link 205, and wear member and track link assembly 606 will be referred to below for simplicity) of the present disclosure, can be used within existing track link assemblies 110. The wear member 200 can be replaced, without the need to replace the entire track link 205. The wear member 200 also provides a part that is relatively easy to replace, by virtue of the need for only a tool, such as a chisel, to pry a used wear member off of a track link 205 and the ability of a new wear member 200 to be mounted onto the track link 205 by mating dowels 265 of the new wear member 200, respectively, and pin holes 340 of the track link 205. In other words, the wear member 200, the track link 205, and the wear member and track link assembly 206 provide serviceability to a track link 205. The arrangement of the dowels 265 on the front portion 250 and the back portion 260 of the wear member 200, and not on the central portion 255, further improves the integrity of the wear member 200, as it reduces an amount of force acting on a central portion 320 of the track link 205 during use. Further, the dowels 265 provide a sufficient coupling between the wear member 200 and the track link 205 beecause they are under a compressive force, e.g., a force exerted by idlers of an idler assembly 145, during use in a track link assembly 206, and during operation of a track-type machine 100. In addition, having two separate link components – the wear member and the track link – may serve to eliminate the need to have an induction-hardened surface on the rail side of the wear member and track link assembly 206 (i.e., on the upper surface of the wear member 200). That is, by having two components, it is possible to eliminate the need for a heat-treating process.

It will be apparent to those skilled in the art that various modifications and variations can be made to the disclosed track link and related track link assembly and method of manufacture, without departing from the scope of the disclosure. Other embodiments of the track link, track link assembly, and method of manufacture will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

1. A wear member for a track link, the wear member comprising:
a plurality of surfaces, including an upper surface and an opposite planar lower surface;
a front portion;
a back portion; and
a plurality of dowels extending from the lower surface, including at least one dowel provided on one of the front portion and at least one dowel provided on the back portion of the wear member.

2. The wear member of claim 1, wherein a diameter of each of the plurality of dowels is 40% of a thickness of the wear member, the thickness being measured between an inner surface and an outer surface of the wear member, or less.

3. The wear member of claim 1, wherein the plurality of dowels includes only two dowels, including a front dowel, as the at least one dowel in the front portion of the wear member, and a back dowel, as the at least one dowel in the back portion of the wear member.

4. The wear member of claim 1, wherein each of the plurality of dowels has a cylindrical shape.

5. The wear member of claim 1, wherein the plurality of surfaces further includes an inner surface, between the upper surface and the planar lower surface, and the planar lower surface has a plurality of recesses, each recess extending from the inner surface toward a dowel, of the plurality of dowels.

6. A wear member for a track link, the wear member comprising:
a plurality of surfaces, including an upper surface and a planar lower surface;
a front portion;
a back portion; and
a plurality of dowels extending from the lower surface, the plurality of dowels being provided offset from each other relative to a central longitudinal axis of the wear member.

7. The wear member of claim 6, wherein a diameter of each of the plurality of dowels is 40% of a thickness of the wear member, the thickness being measured between an inner surface and an outer surface of the wear member, or less.

8. The wear member of claim 6, wherein the plurality of dowels includes only two dowels, including a front dowel, in the front portion of the wear member, and a back dowel, in the back portion of the wear member.

9. The wear member of claim 1, wherein each of the plurality of dowels has a cylindrical shape.

10. The wear member of claim 6, wherein plurality of surfaces further includes an inner surface, between the upper surface and the planar lower surface, and
wherein the planar lower surface has a plurality of recesses, including at least one recess extending from the inner surface toward a dowel, of the plurality of dowels.

11. A wear member and track link assembly comprising:
a track link having a plurality of surfaces, including an upper surface having a plurality of pin holes, and the track link further having a front portion and a back portion, with at least one pin hole being provided in the front portion and at least one pin hole being provided in the back portion of the track link; and
a wear member having:
a plurality of surfaces, including an upper surface and a planar lower surface;
a front portion;
a back portion; and
a plurality of dowels extending from the lower surface, each of the plurality of dowels being provided in one of the front portion and the back portion of the wear member,
wherein the plurality of dowels of the wear member are configured for placement within the plurality of pin holes of the track link, with an interference fit between the plurality of dowels and the plurality of pins connecting the wear member and the track link.

12. The wear member and track link assembly of claim 11, wherein the upper surface of the track link is planar, and wherein the planar upper surface of the track link and the planar lower surface of the wear member are congruent.

13. The wear member and track link assembly of claim 11, wherein a diameter of each of the plurality of dowels is 40% of a thickness of the wear member, the thickness being measured between an inner surface and an outer surface of the wear member, or less.

14. The wear member and track link assembly of claim 11, wherein the plurality of dowels includes only a front dowel, as the at least one dowel in the front portion of the wear member, and a back dowel, as the at least one dowel in the back portion of the wear member, and the plurality of pin holes includes only a front pin hole, as the at least one pin hole in the front portion of the track link, and a back pin hole, as the at least one dowel in the back portion of the track link, and
wherein the front dowel is configured for placement within the front pin hole and the back dowel is configured for placement within the back pin hole.

15. The wear member and track link assembly of claim 11, wherein the wear member is configured for attachment to the track link by an interference fit between the plurality of dowels and the plurality of pin holes.

16. The wear member and track link assembly of claim 11, wherein the plurality of surfaces of the wear member further includes an inner surface, between the upper surface and the planar lower surface, and the planar lower surface has a plurality of recesses, each recess extending from the inner surface of the wear member toward a dowel, of the plurality of dowels.

17. The wear member and track link assembly of claim 11, wherein the plurality of pin holes within the upper surface of the track link are offset from each other relative to a central longitudinal axis of the track link, and the plurality of dowels on the lower surface of the wear member are offset from each other relative to a central longitudinal axis of the wear member.

18. The wear member and track link assembly of claim 11, wherein the plurality of pin holes within the upper surface are aligned with each other on a same side of a central longitudinal axis of the track link, and the plurality of dowels on the lower surface of the wear member are aligned with each other on a same side of the central longitudinal axis of the wear member.

19. The wear member and track link assembly of claim 11, wherein the track link is formed of a first material and the wear member is formed of a second material different from the first material.

20. The wear member and track link assembly of claim 11, wherein each of the plurality of dowels and each of the plurality of pin holes has a cylindrical shape.
